(19) United States
(12) Patent Application Publication
(10) Pub. No.: US 2008/0197683 A1
(43) Pub. Date: Aug. 21, 2008

(54) Motor Vehicle

(75) Inventors: Ulrich Ebbeskotte, Althengstett (DE); Armin Kienzle, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/885,509

(22) PCT Filed: Feb. 18, 2006
(86) PCT No.: PCT/EP06/01490

§ 371 Date: Apr. 18, 2008

(30) Foreign Application Priority Data
Mar. 1, 2005 (DE) 10 2005 009 182.2

(51) Int. Cl. B60N 2/36

(52) U.S. Cl. 297/330; 297/335

(57) ABSTRACT

The invention relates to a motor vehicle with rear seats (3), the seat bench (5) and backrests (6) of which may be placed in a first position in which passengers sit in the direction of travel and into a second position in which the load area of the luggage compartment (4) is increased. The seat bench (5) and the backrests (6) may each be pivoted about a horizontal pivot axis (7, 7′) for adjustment from the first to the second position, whereby locking devices (10) are provided on at least the backrests (6), which fix the backrests (6) to the position when locked. According to the invention, a controller (13) is provided which forcibly couples the locking devices (10) for the backrests (6) to the position of the seat bench (5), such that the backrests (6) can only be adjusted from the first position to the second position thereof, when the seat bench (5) is in the second position thereof.

### BACKGROUND AND SUMMARY OF THE INVENTION

This application is a national stage of PCT International Application No. PCT/EP2006/001490, filed Feb. 18, 2006, which claims priority under 35 U.S.C. §119 to German Patent Application No. 10 2005 009 182.2, filed Mar. 1, 2005, the disclosure(s) of which is (are) expressly incorporated by reference herein.

The invention relates to a motor vehicle having a rear seat that can be folded into a position that increases the load area of the luggage compartment.

German patent document DE 100 56 024 C2 discloses a passenger vehicle with rear seats between a luggage compartment. The seat bench and backrest thereof can be moved by means of adjusting members, on the one hand, into a first position in which passengers are able to sit in the direction of travel and, on the other hand, into a second position in which a loading surface of the luggage compartment is larger. In this connection, the seat bench and the backrest may be moved about horizontal pivot axes by a controller, such that in the first position the rear face of the backrest forms a partition between the luggage compartment and the passenger compartment, while in the second position the rear face of the backrest lengthens the loading surface and the underside of the seat bench forms the partition between the luggage compartment and the passenger compartment. The backrest has locking devices which may be activated via the controller fix it in the first position on the vehicle body. Shortly before the adjusting members are activated by the controller, in order to adjust the backrest from the first into the second position, the controller releases the locking devices. Both the adjusting members and the locking devices are activated and automatically actuated, therefore, by means of the controller.

German patent document DE 198 38 882 A1 discloses a device for folding back the rear seats in a motor vehicle to increase the loading volume, with separate seat elements which may be moved relative to one another. In this case, at least one seat element (or a part of a seat element) may form a part of a loading surface and may be driven by drive means. The latter are preferably positioned on a pivot point of a seating surface, on a point of displacement of a headrest and on a pivot point of a backrest, and thereby allow the rear seats to be automatically folded back and/or set into the upright position.

Finally, a vehicle seat with a foldable backrest and a front foot which bears a seat cushion, is known from German patent document DE 101 57 748 C2. The seat cushion is articulated via a first articulation to a vehicle structure and the backrest is articulated via a second articulation to a vehicle structure, and a kinematic forced coupling is provided between the seat cushion and the backrest, so that a folding motion of the backrest about the second articulation pivots the seat cushion about the first articulation, which may be transferred from at least one position of use into at least one non-use position.

One object of the present invention is to provide an improved embodiment for a motor vehicle of the aforementioned type which precludes in particular, faulty operation of the foldable rear seats when folded back, thereby possibly preventing damage.

this and other objects and advantages are achieved by the motor vehicle folding seat arrangement according to the invention, which is based on the general idea of providing a controller which forcibly couples unlocking of the backrest of the rear seat to the position of a seat bench of the rear seat such that the backrest may only be folded down when the seat bench has been previously folded out of the pivoting range of the backrest.

The invention thus prevents faulty operation of the rear seats in which, for example, the backrest might be folded down without previously setting the seat bench upright, so that the backrest is placed on the seat bench, jamming belt locks and damaging the backrest and the seat bench. By preventing jamming of the belt locks between the backrest and the seat bench, the backrest cover is also protected from damage.

The invention also simplifies the operation of the foldable rear seats, as only one lock (namely that of the seat bench) has to be manually actuated, and a second manual unlocking of the backrest is dispensed with. The elimination of the manual unlocking of the backrest makes a locking handle dispensable on the backrest, improving the appearance and design of the backrest.

Expediently, a trip device actuates the locking device for releasing the backrest as soon as the seat bench reaches the second position. This allows a collision-free adjustment of the rear seats from the first position into the second position thereof, because the backrest can be adjusted only when the seat bench is completely folded forward, and has adopted its second position. The trip device may, for example, be a sensor which is configured to transmit a signal to the controller. Such sensors, such as for example rotary switches or push-button switches, may be easily and cost-effectively produced and offer, through the long-term use thereof, a high degree of reliability relative to the functional reliability.

According to a preferred embodiment of the invention, the seat bench and the backrest are configured for manual adjustment between the first and second positions. Both the seat bench and the backrest may, therefore, be easily and rapidly adjusted with few handles between the first and the second position, without need of complicated, costly and delicate adjusting devices, such as for example electric control motors. The manual adjustability permits the electrical control motors to be dispensed with, so that the foldable rear seats can be produced more cost-effectively, and are also more robust and functionally reliable.

Expediently, the seat bench and the backrest are divided into parts, and each part may be adjusted between the first and second positions independently from the other. For example, a division of the rear seat bench of one third to two thirds relative to the rear seat bench width is conceivable, whereby the luggage compartment may be separately increased according to requirements. At the same time, both when folding up only one part of the rear seats and also when folding up both parts of the rear seats, jamming of the belt locks between the seat bench and the backrest or damage to the backrest cover is prevented, as the respective backrest may only be adjusted from the first position when the associated seat bench part has reached the second position.

According to a preferred embodiment of the invention, a spring is provided which rotates the backrest about the pivot axis when the locking device is unlocked, at least slightly in the direction of the seat bench. As a result, it is ensured that the backrest is reliably and visibly released and/or adjusted from its first position, as soon as the seat bench has reached the second position. At the same time, the user is made aware of the now unlocked backrest by the easy pivoting of the backrest, whereby the relevant rear seat is prevented from being used as a vehicle seat by a passenger when the rear seat bench is unlocked, which could be dangerous.

In a further advantageous embodiment, the controller is configured such that the locking device of the backrest is unlocked only when the vehicle doors are opened. This represents an additional safety mechanism as only when the vehicle door is opened is it possible to assume that the vehicle is stationary and thus a safe folding back of the rear seats and/or a safe displacement from the first into the second position is possible.

It is understood that the aforementioned features and the features still to be mentioned below may be used not only in the particular combination provided, but also in other combinations or alone, without departing from the scope of the present invention.

Preferred embodiments of the invention are shown in the drawings and are described in more detail in the following description, the same reference numerals referring to components which are the same or functionally the same or similar.

### BRIEF DESCRIPTION OF THE DRAWINGS

FIG. 1 is a longitudinal section through a passenger compartment with a rear seat according to the invention; and

FIG. 2 is a detailed view of a locking device of a backrest of the rear seat.

### DETAILED DESCRIPTION OF THE DRAWINGS

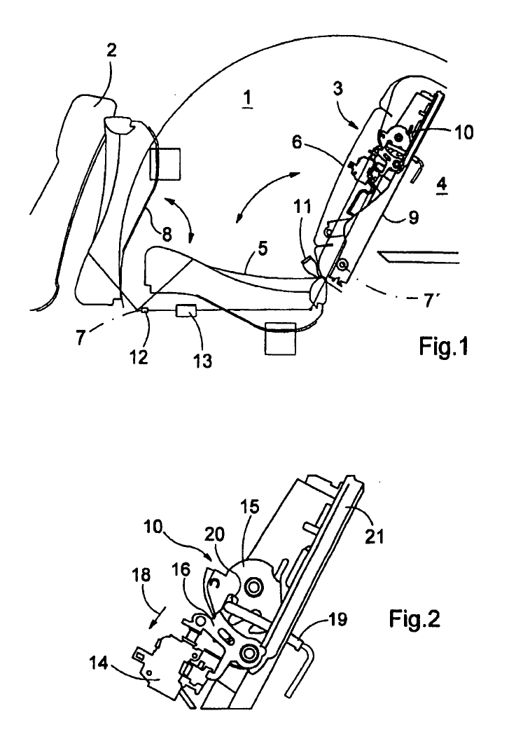

According to FIG. 1, a passenger compartment 1 (shown partially) of a motor vehicle (not shown) comprises a front seat 2 as well as a rear seat 3 arranged to the rear in the direction of travel. A luggage compartment 4 is located in the direction of travel behind the rear seat 3, and it is also possible that a further seat row (not shown) is arranged there. The rear seat 3, which may, for example, be continuous over the width of the vehicle, or preferably asymmetrically divided, comprises a seat bench 5 as well as a backrest 6. An asymmetrical division, in particular, of the seat bench 5 and/or the backrest 6 allows an individual and adaptable enlargement of the luggage compartment 4.

The rear seat 3 (backrest 6) is shown in FIG. 1 in a first position in which passengers may sit, facing in the direction of travel. According to the invention, the seat bench 5 and the backrest 6 may also be moved into a second position, in which a loading surface of the luggage compartment 4 is enlarged. In the second position, the seat bench 5 is pivoted about a horizontal pivot axis 7 (which extends according to FIG. 1 at right angles to the image plane), to the front in the direction of the front seat 2 and adopts a substantially upright position. (See FIG. 1.) In the second position, an underside 8 of the seat bench 5 forms a partition between the passenger compartment 1 and the luggage compartment 4.

To adjust the backrest 6 into the second position, it is pivoted in the direction of the front seat 2 about the pivot axis 7′ which, as shown in FIG. 1, also extends at right angles to the image plane. A rear face 9 of the backrest 6 lengthens the loading surface, and thus enlarges the luggage compartment 4 when the second position is reached.

Such a pivoting of the seat bench 5 and the backrest 6 for enlarging the luggage compartment 4 is generally known, as well as locking devices 10 which are provided on the backrest 6 and which in the locked position fix the backrest 6 in the first position. The locking devices 10 anchor the backrest 6 in the locked position to a fixed point on the bodywork side and, when the backrest 6 is divided, also to the respective other part of the backrest 6.

According to the invention, therefore, a controller 13 is provided which ties the locking devices 10 of the backrest 6 to the position of the seat bench 5, such that the backrest 6 may only be adjusted from its first position into its second position when the seat bench 5 is in the second position. Such compulsory coupling prevents faulty operation of the foldable rear seats 3, in which the backrest 6 is folded down without first setting the seat bench 5 upright hereby, for example, jamming a belt lock 11 between the backrest 6 and the seat bench 5 and damaging itself either/or a cover of the backrest 6. The release of the backrest 6 from the first position thereof is, in principle, possible only when the seat bench 5 has adopted its second position.

In order to assure that the seat bench 5 has adopted the second position, a trip device 12 may be provided which actuates the locking devices 10 to release the backrest 6, as soon as the seat bench 5 has reached the second position. Such a trip device 12 may, for example, be a sensor which is configured to transmit a signal to the controller 13, and which when reaching the second position of the seat bench 5 emits a corresponding signal to the controller 13, whereupon said controller unlocks the locking devices 10 on the backrest 6. It is thus conceivable, for example, that the trip device 12 is arranged on the pivot axis 7 of the seat bench 5 and, for example, is configured as a rotary switch or as a push-button switch.

In order to obviate the need for additional protection against inadvertent release of the backrest 6, according to one embodiment of the invention, it may be provided that the controller 13 unlocks the locking devices 10 of the backrest 6 only when the vehicle door is opened (and it may therefore be assumed that the vehicle is stationary). A significant safety aspect is thus provided; in particular, unlocking of the locking devices 10 during a journey is prevented. An open position of the vehicle door may therefore, for example, be detected via a central locking system coupled to the controller 13.

Generally, the controller 13 may also comprise or be configured as a simple time-controlled relay, which can be activated by the sensor and in the activated state unlocks the locking devices 10 of the backrest 6. With a controller 13 configured as a time-controlled relay, additional dependent functions may only be carried out conditionally, such as for example a displacement between the first and the second position only when the vehicle door is opened.

In order to facilitate further the displacement of the rear seats 3 into the second position thereof, a spring may be provided (not shown in more detail), which rotates the backrest 6 about the pivot axis 7′ at least slightly in the direction of the seat bench 5 (for example by approximately 10 to 30% of the total pivoting path), when the locking device 10 is unlocked. Easy rotation of the backrest 6 when the locking device 10 is unlocked also has the advantage that a user of the motor vehicle is made immediately aware of the unlocked position of the backrest 6, reducing the risk of driving away with an unlocked backrest 6 (and thus with a luggage compartment 4 which is insufficiently secured relative to the passenger compartment 1). Thus, by prompting locking of the locking device 10, in the event of a sharp braking maneuver, for example during an accident, this feature helps to prevent luggage which is stored in the luggage compartment 4 from being thrust forward in an uncontrolled manner into the passenger compartment 1.

Generally, the seat bench 5 and the backrest 6 are configured for manual adjustment between the first and the second position, whereby corresponding adjusting devices, such as for example electric control motors may be dispensed with and thereby the construction may be manufactured as a whole more robustly and more cost-effectively.

According to FIG. 2, the locking device 10 comprises an electric control motor 14, a rotary latch 15 as well as a locking pawl 16. The electric control motor 14 cooperates with the locking pawl 16 via a spindle drive 17, and causes a release of the rotary latch 15 when adjusting the locking pawl 16 in the direction 18. The rotary latch 15 engages with a latching recess 20 in a locking strap 19 which is fixedly connected to the bodywork of the motor vehicle. The locking device 10 is thus fixedly arranged inside the backrest 6 on a backrest frame 21, the locking strap 19 projecting therein, such that the rotary latch 15 is latched thereto when the backrest 6 is located in the first position.

As mentioned above, the locking device 10 according to the invention for the rear seats 3 may be produced both with a rear seat arrangement which is continuous over the vehicle width and with divided rear seats 3. If the seat bench 5 and the backrest 6 are divided, preferably each part may be displaced independently from the other, between its first and its second position.

In summary, for a motor vehicle with rear seats 3 arranged between a luggage compartment 4 and a passenger compartment 1, the invention provides a controller 13, which allows a displacement of the backrest 6 in the direction of the front seat 2 only when the seat bench 5 has been previously moved into the second position. To this end, the locking devices 10 of the backrest 6 are tied to the position of the seat bench 5 such that the backrest 6 may be displaced from its first position (in which passengers may sit in the direction of travel) into its second position (in which the rear face 9 of the backrest 6 enlarges the luggage compartment 4) only when the seat bench 5 is in its second, almost vertical, position.

As a result, incorrect operation of the rear seats 3, in which the backrest 6 is folded onto the seat bench without the latter having first been set upright, (which can, for example, jam belt locks 11 and cause damage between the backrest 6 and the seat bench 5), can be prevented. Moreover, damage to a cover of the backrest 6 may also be prevented in this manner. The locking devices 10 may preferably be activated electrically.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. A motor vehicle comprising:
at least a rear seat which is disposed between a vehicle luggage compartment and a passenger compartment, and which is configurable in a first position, in which passengers can sit facing a direction of travel, and in a second position, in which a loading surface of the luggage compartment is enlarged; wherein,
said at least a rear seat comprises a seat bench and a backrest which are movable about respective horizontal pivot axes, such that in the first position, a rear face of the backrest forms a partition between the passenger compartment and the luggage compartment, and in the second position the rear face of the backrest lengthens the loading surface, with the underside of the seat bench forming the partition between the passenger compartment and the luggage compartment;
locking apparatus is provided at least on the backrest, which in the locked position, fixes the backrest in the first position; and
the motor vehicle further comprises a controller which ties operation of the locking apparatus of the backrest to a current position of the seat bench, such that the backrest can be displaced from its first position into its second position; only when the seat bench is in the second position; and
the controller is configured such that it unlocks the locking apparatus only when a vehicle door is open.

13. The motor vehicle as claimed in claim 12, further comprising a trip device which actuates the locking apparatus for releasing the backrest when the seat bench reaches the second position.

14. The motor vehicle as claimed in claim 12, wherein the trip device is a sensor that is configured to transmit a signal to the controller as soon as the seat bench reaches the second position.

15. The motor vehicle as claimed in claim 14, wherein the trip device is arranged on the pivot axis of the seat bench.

16. The motor vehicle as claimed in claim 15, wherein the sensor is configured as one of a rotary switch and a push-button switch.

17. The motor vehicle as claimed in claim 12, wherein the seat bench and the backrest are configured for manual displacement between the first and the second position.

18. The motor vehicle as claimed in claim 12, wherein the locking apparatus comprises at least one of an electric control motor, a rotary latch, and a locking pawl.

19. The motor vehicle as claimed in claim 18, wherein at least one of the following is true:
the control motor cooperates with the locking pawl; and
the locking pawl cooperates with the rotary latch.

20. The motor vehicle as claimed in claim 12, wherein the controller comprises a relay which may be activated by the sensor and in the activated state unlocks the locking apparatus.

21. The motor vehicle as claimed in claim 12, further comprising a spring which rotates the backrest at least slightly in the direction of the seat bench when the locking device is unlocked.

22. The motor vehicle as claimed in claim 12, wherein the seat bench and the backrest are divided into parts, and each part is adjustable independently from the other between the first and the second position.

23. A vehicle seat arrangement comprising:
a seat bench;
a backrest, the seat bench and backrest being deployable in a first position, with the seat bench situated substantially horizontally and the backrest situated substantially virtually between a vehicle luggage compartment and a vehicle passenger compartment, and in a second position in which the seat bench is pivoted forward into a vertical position and the backrest is pivoted forward into a horizontal position;
at least one locking device which, when locked, fixes the backrest in the first position; and
a controller;
wherein, the controller is configured to actuate the locking device to release the seat back so that it may be rotated from the first position to the second position only when the seat bench has been rotated into the second position.

24. The vehicle seat arrangement according to claim 23, wherein the controller is further configured so that the seat back is released to rotate into the second position only when a vehicle door is open.
